(19) United States
(12) Patent Application Publication
(10) Pub. No.: US 2022/0395731 A1
(43) Pub. Date: Dec. 15, 2022

(54) APPARATUS AND METHOD FOR DETERMINING A STIMP RATING FOR A GOLF GREEN

(71) Applicant: Andrew John Grant, Stamford, CT (US)

(72) Inventor: Andrew John Grant, Stamford, CT (US)

(73) Assignee: Andrew Grant, Stamford, CT (US)

(21) Appl. No.: 17/346,241

(22) Filed: Jun. 12, 2021

(51) Int. Cl. A63B 57/00; H04Q 9/00

(52) U.S. Cl. CPC A63B 57/00; H04Q 9/00; H04Q 2209/43; A63B 2225/50; A63B 2220/20

(57) ABSTRACT

An apparatus and method for determining a stimp rating of a golf putting green surface. The stimp device measures distance traversed over a horizontal surface through a rotary encoder with a predetermined force applied to calculate the Stimp rating of the surface. A microprocessor automates the process and the calculation and communicates the results to the user via a display or wireless communication with a mobile computing device.

### CROSS-REFERENCE TO RELATED APPLICATIONS

Provisional Patent: APPARATUS AND METHOD FOR DETERMINING A STIMP RATING FOR A GOLF GREEN

Application No: 62/705,160

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to golf course greens keeping, and more particularly to apparatus and methods for determining a cut length of the grass on a golf green playing surface.

Stimp ratings on putting greens can only currently be calculated using a StimpMeter and a specific measurement process. The StimpMeters are not available to the general public. A conventional StimpMeter is not a quick device and process to use. The StimpMeter is not very portable and cannot automatically calculate the stimp rating for the user or communicate it to an app on someone's cell phone.

The only device that calculates Stimp ratings currently is a StimpMeter. The standard StimpMeter is a long ramp (typically metal or wood) that is approximately 36 inches in length. The process for calculating the Stimp is that the user allows a golf ball roll down the StimpMeter in a few iterations and then averages the distance the ball rolls across the putting green to calculate Stimp.

As can be seen, there is a need for improved apparatus and methods that automates the stimp measurement process and communicates the stimp rating to a visual display.

### BRIEF SUMMARY OF THE INVENTION

An apparatus and method for determining a stimp rating of a golf putting green surface. The stimp device measures distance traversed over a horizontal surface through a rotary encoder with a predetermined force applied to calculate the Stimp rating of the surface. A microprocessor automates the process and the calculation and communicates the results to the user via a display or wireless communication with a mobile computing device

### BRIEF DESCRIPTION OF THE SEVERAL VIEWS OF THE DRAWING

FIG. 1: is a perspective view of the electronic stimp device;

FIG. 2: is side cross-section view of the electronic stimp device;

FIG. 3: is a top cross-section view of the electronic stimp device;

FIG. 4: is a bottom cross-section view of the electronic stimp device;

FIG. 5a: is a view of the pull-back method of winding the torsion spring;

FIG. 5b: is a view of the lever alternative body for winding the torsion spring;

FIG. 6: is view of electronic stimp device in-use;

FIG. 7: is alternative embodiment of the electronic stimp device;

FIG. 8: is alternative embodiment of the electronic stimp device; and

FIG. 9: is a view of the layers of a putting green

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, embodiments of the present invention provide an apparatus and method for automatically measuring and determining a Stimp rating of a putting green or any surface. The stimp rating can be displayed on a display of the device or communicated via wireless technology to other electronic devices, such as a cell phone, tablet, or computer.

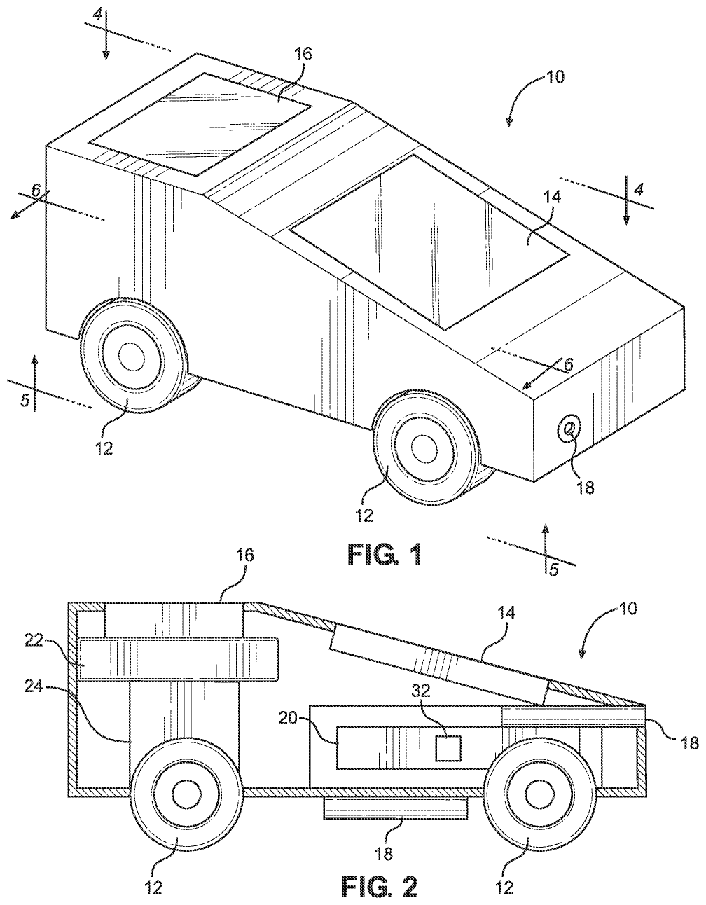

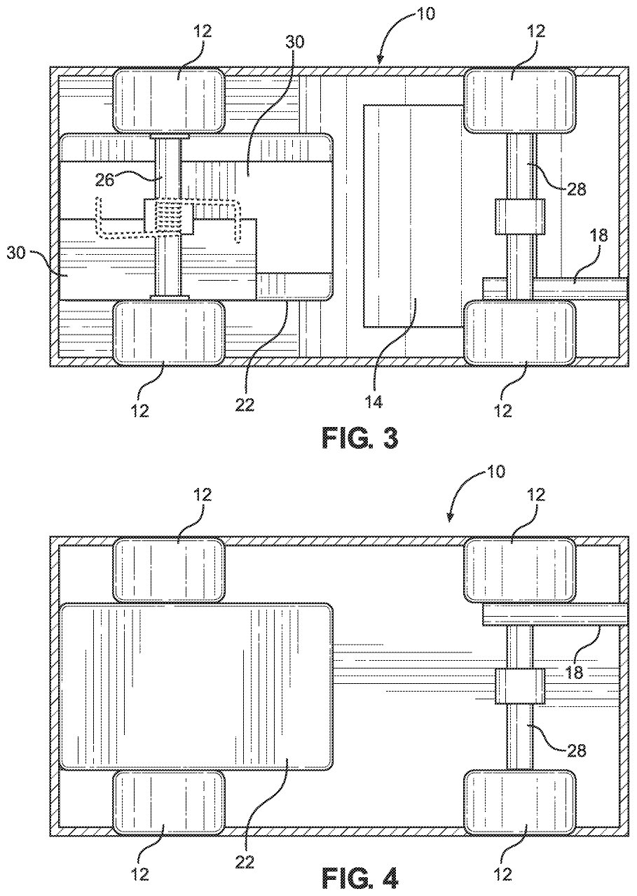

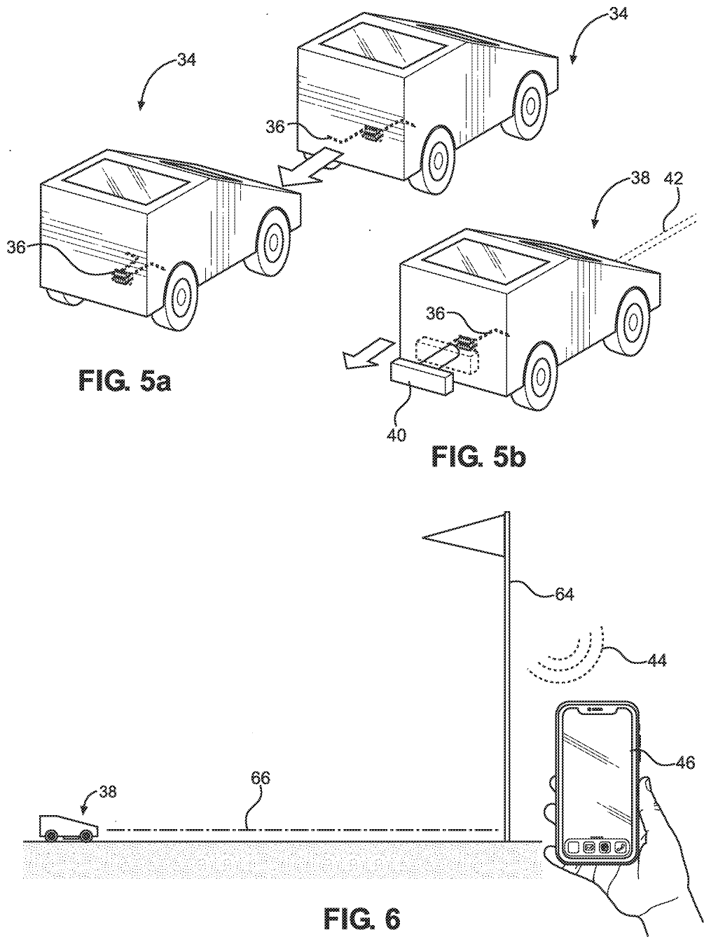

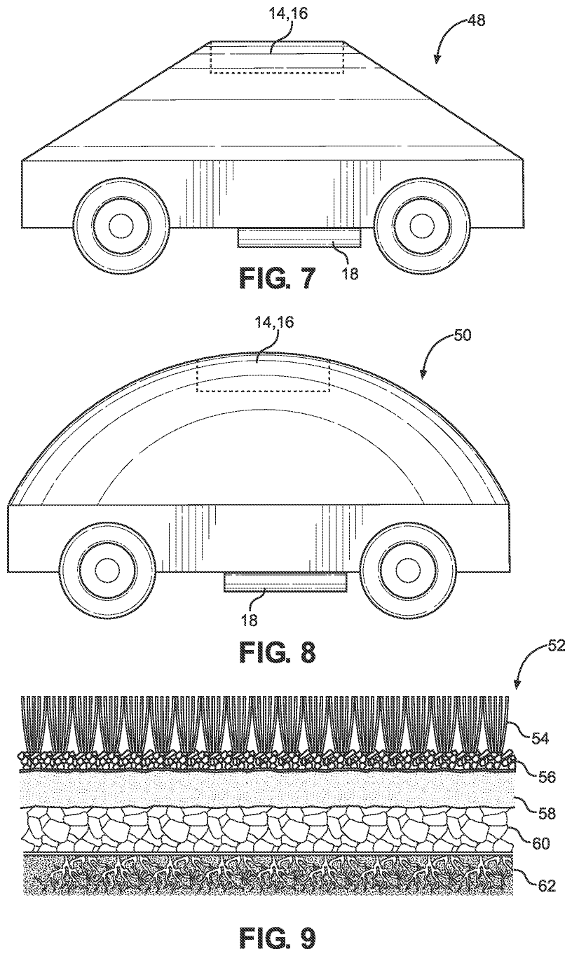

An electronic stimp device 10 and methods of utilizing the same are illustrated in reference to the drawings of FIGS. 1-9. The electronic stimp device 10 includes a device chassis supporting a plurality of ground wheels 12 for supporting the stimp device 10 on a surface, typically a putting golf green 52. A control panel 14, such as a touch pad, is provided for interacting with the stimp device 10. A display screen 16 may also be provided for providing a presentation of a stimp rating measured by the device 10. As will be appreciated the control panel 14 and display screen 16 may be integrated into a unitary device.

A laser 18 is provided to project a laser beam 42 to align the stimp device 10 with a desired traversal pathway 66 across the golfing green 52 surface

22: is the Battery of the Electronic Stimp Device

36: is the Torsion Spring and accompanying gears/gearbox

38: is the Lever Embodiment of the Electronic Stimp Device

40: is the Lever

42: is the Laser 18 Beam

44: is the Bluetooth or Wi-Fi Signal

46: is a Personal Electronic Device

48: is an Alternate Body for the Electronic Stimp Device

50: is an Alternate Body for the Electronic Stimp Device

52: is a Putting Green

54: is Grass

56: is Infill

58: is Decomposed Granite

60: is Filtering Rock

62: is the Soil

64: is a Golf Flag

66: is the Path of Travel

In the non-limiting embodiment shown, the stimp device 10, the plurality of ground wheels 12 includes 4 ground wheels. The front 2 wheels 12 may be connected to each other via a front axle 28 and the back 2 wheels 12 may be connected to each other via a rear axle 26. One or the rear axle 26 or the front axle 28 is connected to a torsion spring 36, carried within a torsion spring container 24.

The torsion spring 36 is configured to propel the stimp device 10 forward. Different types of springs and gears can be used instead of the torsion spring 36 to propel the stimp device 10 across the green surface 52. The torsion spring 36 can be charged or coiled up in a variety of ways, such as counter rotation of the ground wheels 12 on the axle 26, 28 carrying the torsion spring 46, like a pullback toy car, or by actuation of a lever 40, pull cord, or other charging mechanism, that charges/coils up the torsion spring 36. The torsion spring 46 is calibrated to deliver a known force to propel the stimp device 10.

The rotary encoder 30 may be connected to at least one of the ground wheels 12 and measures the number of rotations taken by the back wheels/axel as the stimp device 10 it traverses the green surface 52. The distance the stimp device 10 traverses on the green surface 52 is measured by one or more of a rotary encoder 30 or the measured rotation of at least one of the plurality of ground wheels 12. In some embodiments, the stimp device 10 can measure the traversed distance using both measurements for redundancy and accuracy of the traversed distance measurement.

This traversed distance information is sent to a microcontroller 32 which may then process and determine the stimp rating based on the applied force of the torsion spring 46. The stimp rating is then computed by the microcontroller 32 and presented on the electronic display screen 16. In some embodiments, the stimp rating may be communicated to other portable electronic devices 46, such as a smartphone, tablet, wearable device, and the like, via a wireless communications protocol 44, such as Bluetooth, Wi-Fi, near field communication, and the like via a wireless communications adapter. Blue tooth or the wireless adapters will help communicate the Stimp rating to another electronic device 46. This is not needed as the Stimp rating will also be displayed on the device 10 display 16.

A printed circuit board (PCB) 20 would carry the interconnections with the electronic components of the stimp device 10 and mounting the components together on the device chassis. The electronics may be powered by a battery 22. Programming code for determining the stimp rating would be loaded onto the microcontroller 32.

In use, a person would typically employ the stimp device 10 on a putting green 52 to have the stimp device 10 automatically measure the putting green's 52 stimp rating. This is done by charging the torsion spring 36, such as counter rotation of the ground wheels 12 connected to the torsion spring 36, until a click is heard indicating the torsion spring 36 is charged to the predetermined force, or by pulling the lever 40 on the device that charges the torsion spring 36.

As will be appreciated, the stimp device 10 could measure a ground distance and send it wirelessly for other uses besides calculating the Stimp Rating of the surface. Which is affected by the characteristics of the green surface 52, including the length and type of the grass 54, an infill material 56, a decomposed granite layer 58, a filtering rock layer 60, and a soil layer 62:

It should be understood, of course, that the foregoing relates to exemplary embodiments of the invention and that modifications may be made without departing from the spirit and scope of the invention as set forth herein

1. An apparatus and method for determining a stimp rating of a golf putting green surface.

2. An apparatus, using a rotary encoder, and method for determining a stimp rating of a golf putting green surface.

3. An apparatus and method for determining a stimp rating of a golf putting green surface and transmitting the information to a wireless device.

4. An apparatus, using a rotary encoder, and method for determining a stimp rating of a golf putting green surface and transmitting the information to a wireless device.

5. An apparatus and method for determining a stimp rating of a golf putting green surface and transmitting the information to a wireless device such as smart phone.

6. An apparatus, using a rotary encoder, and method for determining a stimp rating of a golf putting green surface and transmitting the information to a wireless device such as smart phone.

7. An apparatus and method for determining a stimp rating of a flat surface

8. An apparatus, using a rotary encoder, and method for determining a stimp rating of a flat surface

9. An apparatus and method for determining a stimp rating of a flat surface and transmitting the information to a wireless device.

10. An apparatus, using a rotary encoder, and method for determining a stimp rating of a flat surface and transmitting the information to a wireless device.

11. An apparatus and method for determining a stimp rating of a flat surface and transmitting the information to a wireless device such as smart phone.

12. An apparatus, using a rotary encoder, and method for determining a stimp rating of a flat surface and transmitting the information to a wireless device such as smart phone.

13. An apparatus and method for measuring ground distance

14. An apparatus, using a rotary encoder, and method for measuring ground distance

15. An apparatus and method for measuring ground distance and transmitting the information to a wireless device.

16. An apparatus, using a rotary encoder, and method for measuring ground distance and transmitting the information to a wireless device.

17. An apparatus and method for measuring ground distance and transmitting the information to a wireless device such as smart phone.

18. An apparatus, using a rotary encoder, and method for measuring ground distance and transmitting the information to a wireless device such as smart phone.
